(19) United States
(12) Patent Application Publication
(10) Pub. No.: US 2013/0294746 A1
(43) Pub. Date: Nov. 7, 2013

(54) SYSTEM AND METHOD OF GENERATING MULTIMEDIA CONTENT

(71) Applicant: WOCHIT, INC., Wilmington, DE (US)

(72) Inventors: Ran OZ, Maccabim (IL); Dror GINZBERG, Nir Zvi (IL)

(73) Assignee: Wochit, Inc., Wilmington, DE (US)

(21) Appl. No.: 13/874,496

(22) Filed: May 1, 2013

Related U.S. Application Data
(60) Provisional application No. 61/640,748, filed on May 1, 2012.
(60) Provisional application No. 61/697,833, filed on Sep. 7, 2012.

(51) Int. Cl. H04N 9/87

(52) U.S. Cl. CPC H04N 9/87
USPC 386/241

(57) ABSTRACT

A system arranged to generate multimedia content, constituted of: a textual input module; an audio input module arranged to receive a human generated audio of the text; a contextual analysis module in communication with the textual input module and arranged to extract metadata from the received textual input; a media asset collection module arranged to retrieve a plurality of media assets responsive to the metadata of the received textual input; an alignment module in communication with the audio input module and the textual input module, the alignment module arranged to determine time markers in the received audio input for predetermined words in the received textual input; a video creation module arranged to create a video clip responsive to the received audio input, the determined time markers and the retrieved plurality of media assets of the media asset collection module; and an output module arranged to output the created video clip.

### BACKGROUND OF THE INVENTION

The present invention relates to the field of generating multimedia content and in particular to a system and method for generating multimedia content from a text or audio input.

The present field of multimedia content requires a developer to act almost like a producer, in that the developer must first develop a text, convert the text to speech, determine what visual content is to be added, and then adjust resultant output so as to fit a predetermined time slot. Such a process is labor intensive, and is thus not generally economical.

In the area of news information, wherein the facts and story line are constantly changing, text based information remains the leading source. A certain amount of multi-media content is sometimes added, usually by providing a single fixed image, or by providing some video of the subject matter. Unfortunately, in the ever changing landscape of news development, resources to properly develop a full multi-media presentation are rarely available.

A number of sources are arranged to present push news information to registered clients, thus keeping them up to date regarding pre-selected area of interest. The vast majority of these sources are text based, and are not provided with multi-media information.

Wibbitz, of Tel Aviv, Israel, provides a text-to-video platform as a software engine which matches a visual representation for the text, adds a computer generated voice-over narration and generates a multi-media video responsive to the provided text. Unfortunately, the computer generated voice-over narration is often unnatural. Additionally, the tool provided is primarily for publishers, requiring a text input, and is not suitable for use with an audio input.

### SUMMARY OF THE INVENTION

Accordingly, it is a principal object of the present invention to overcome at least some of the disadvantages of prior art methods of multi-media content generation. Certain embodiments provide for a system arranged to generate multimedia content, the system comprising: a textual input module arranged to receive a textual input; an audio input module arranged to receive an audio input, wherein the received audio input is a human generated audio and the textual input is a textual representation of the human generated audio; a contextual analysis module in communication with the textual input module and arranged to extract metadata from the received textual input; a media asset collection module arranged to retrieve a plurality of media assets responsive to the metadata of the received textual input; an alignment module in communication with the audio input module and the textual input module, the alignment module arranged to determine time markers in the received audio input for predetermined words in the received textual input; a video creation module arranged to create a video clip responsive to the received audio input, the determined time markers and the retrieved plurality of media assets of the media asset collection module; and an output module arranged to output the created video clip.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1A illustrates a high level block diagram of a system for generating multimedia content from textual input;

FIG. 1B illustrates a high level flow chart of the method of operation of the system of FIG. 1A;

FIG. 2A illustrates a high level block diagram of a system for generating multimedia content from audio input;

FIG. 2B illustrates a high level flow chart of the operation the system of FIG. 2A;

FIG. 3A illustrates a high level block diagram of a system for generating multimedia content from one of a textual input and an audio input;

FIG. 3B illustrates a high level flow chart of the operation of the system of FIG. 3A;

FIG. 4 illustrates a high level flow chart of a method of producing a video clip, according to certain embodiments;

FIG. 5A illustrates a high level block diagram of a system for outputting video clips to a plurality of client modules; and

FIG. 5B illustrates a high level flow chart of the operation of the system of FIG. 5A.

### DETAILED DESCRIPTION OF PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

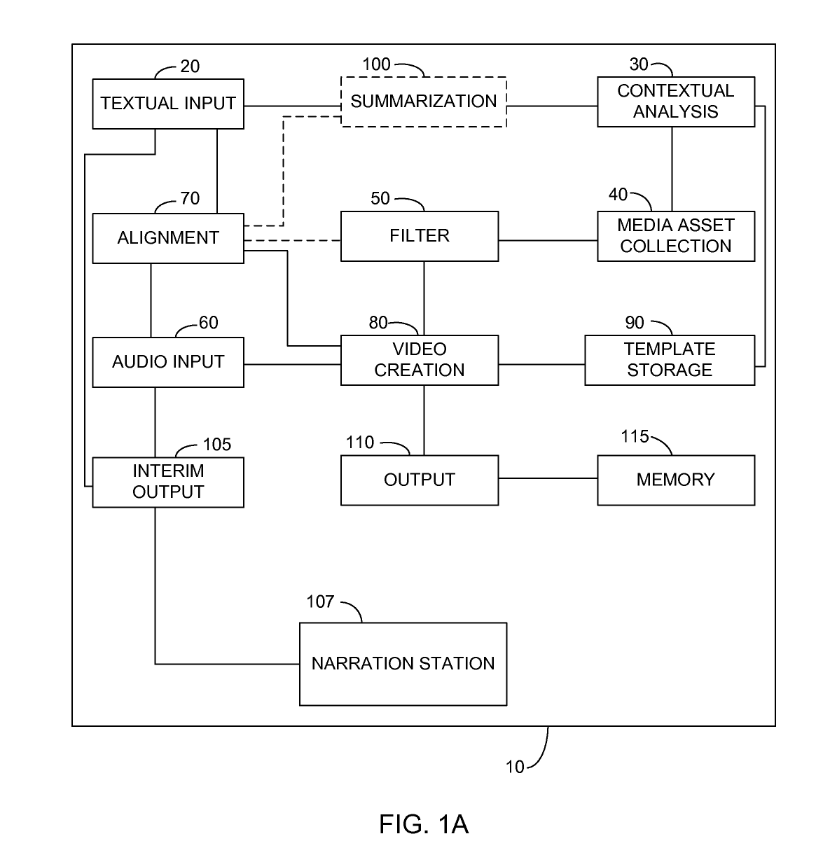

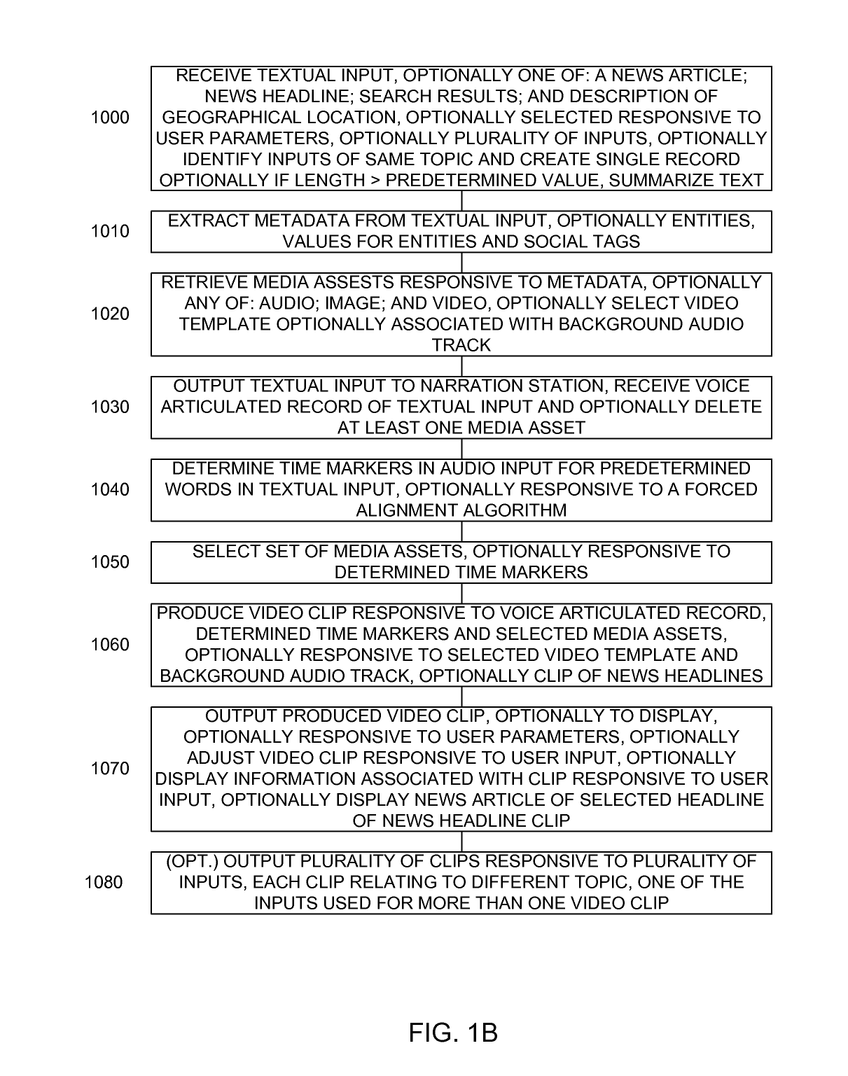

FIG. 1A illustrates a high level schematic diagram of a system 10, comprising: a textual input module 20; a contextual analysis module 30; a media asset collection module 40; a filtering module 50; an audio input module 60; an alignment module 70; a video creation module 80; a template storage 90; an optional summarization module 100; an interim output module 105; a narration station 107; an output module 110; and a memory 115. Template storage 90 has stored thereon a plurality of video templates. In one embodiment, each video template comprises a set of editing rules. The editing rules comprise, without limitation, any of: effect types; transition types between different media assets; rate of change of media assets; and speed of transitions between media assets. In one embodiment, template storage 90 has further stored thereon a plurality of template components, each associated with one or more video templates. Template components comprise, without limitation, any of: graphs; headlines; maps; and full screen images. In one embodiment, template storage 90 further comprises a plurality of background audio tracks. Each video template is associated with at least one particular background audio track.

Textual input module 20 is in communication with at least one data provider and/or database and optionally with optional summarization module 100. Contextual analysis module 30 is in communication with textual input module 20, optionally via summarization module 100, and with media asset collection module 40. In the event that summarization module 100 is not provided, contextual analysis module 30 is in communication with textual input module 20. Media asset collection module 40 is further in communication with filtering module 50. In one embodiment, media asset collection module 40 communicates with the one or more media asset databases. In one embodiment, the communication is over the Internet. Filtering module 50 is further in communication with video creation module 80 and optionally with alignment module 70. Audio input module 60 is in communication with alignment module 70, video creation module 80 and interim output module 105. Alignment module 70 is further in communication with textual input module 20 and optionally in communication with summarization module 100. Video creation module 80 is further in communication with alignment module 70, template storage 90 and output module 110. Interim output module 105 is in communication with narration station 107 and memory 115 is in communication with output module 110. Template storage 90 is further in communication with contextual analysis module 30.

Each of textual input module 20; contextual analysis module 30; media asset collection module 40; filtering module 50; audio input module 60; alignment module 70; video creation module 80; template storage 90; optional summarization module 100; interim output module 105; narration station 107; and output module 110 may be constituted of special purpose hardware, or may be a general computing device programmed to provide the functionality described herein. The instructions for the general computing device may be stored on a portion of memory 115 without limitation.

The operation of system 10 will now be described by the high level flow chart of FIG. 1B. In stage 1000, a textual input is received by textual input module 20 from a particular data provider or database. In one embodiment, the textual input comprises a textual article received by an RSS feed, and in such an embodiment textual input module 20 is arranged to extract at least a portion of the textual data from the RSS feed. In the event the RSS feed further comprises media content, such as images or video, textual input module 20 is further arranged to extract the media content. In another embodiment, the textual input is extracted from the particular data provider or database by textual input module 20. As will be described below, in one embodiment the textual input is one of: a news article; a news headline; search results of a search engine; and a textual description of a geographical location. As will be described further below, in one embodiment, the textual input is selected from a plurality of textual inputs responsive to user parameters stored on memory 115.

In one embodiment, in the event the length of the received textual input exceeds a predetermined value, optional summarization module 100 is arranged to summarize the received input. In one non-limiting embodiment, the received textual input is summarized to contain about 160 words. In another embodiment, the received textual input is summarized to contain about 15 words. In one embodiment, the summarization is responsive to a text summarization technique known to those skilled in the art, and thus in the interest of brevity will not be further detailed.

In one embodiment, as will be described below, a plurality of textual inputs are received, such as a plurality of news articles, optionally from a plurality of news providers. In another embodiment, as will be described below, a plurality of textual inputs are received and textual input module 20 is arranged to: identify a set of textual inputs which are related to the same topic; and create a single textual record from the related set of textual inputs.

In stage 1010, the textual input of stage 1000 is analyzed by contextual analysis module 30. In the embodiment where the input of stage 1000 is summarized, the summarized input is analyzed by contextual analysis module 30. In one embodiment, the analysis is performed by Natural Language Processing (NLP).

Contextual analysis module 30 is arranged to extract metadata from the analyzed textual input. In one embodiment, the extracted metadata comprises at least one entity, such as one or more persons, locations, events, companies or speech quotes. In another embodiment, the extracted metadata further comprises values for one or more of the extracted entities. In another embodiment, the extracted metadata further comprises relationships between extracted entities. For example, a relationship is determined between a person and a company, the relationship being that the person is an employee of the company. In another embodiment, the extracted metadata comprises social tags arranged to provide general topics related to the analyzed textual input. Examples of social tags can include, without limitation: manmade disaster; gastronomy; television series; and technology news. In one embodiment, the social tags are created responsive to the analysis of the textual input. In another embodiment, the metadata further comprises extracted information such as the date and time of publication, the author and the title.

In stage 1020, media asset collection module 40 is arranged to retrieve a plurality of media assets from one or more media asset databases, responsive to the extracted metadata of stage 1010. In one embodiment, the retrieved media assets comprise, without limitation, one or more of: images, such as editorial images or created images; videos, such as editorial videos or created videos; and audio portions, such as music and sound effects. In one embodiment, the media assets are selected by comparing the extracted metadata of stage 1010 to the metadata of the media assets. In one embodiment, media asset collection module 40 is further arranged to compare the extracted metadata of stage 1010 to properties of the video templates and template components stored on template storage 90 and select a particular video template and particular template components responsive to the comparison. In the event that one or more media assets were extracted by textual input module 20 in stage 1000, the one or more media assets are added to the media assets retrieved by media asset collection module 40 as potential media assets. In another embodiment, the plurality of media assets are retrieved responsive to the length of the input of stage 1000. For example, a larger number of media assets are retrieved for a longer textual input than for a shorter textual input.

In stage 1030, interim output module 105 is arranged to output the received textual input of stage 1000 to narration station 107 and in the embodiment where the textual input is summarized, interim output module 105 is arranged to output the summarized text to narration station 107. The received text is then narrated by a narrator, preferably a human narrator, the narration being received by narration station 107 and transmitted to interim output module 105 as a voice articulated record. The voice articulated record is then fed to audio input module 60.

Contextual analysis and search results based thereon, although accurate, can have some degree of errors and ambiguity. In addition, such techniques do not weight human comprehension, opinion or emotion. The retrieved media assets may therefore contain irrelevant or inaccurate media assets with respect to the input, or summarized input, of stage 1000. In one embodiment, interim output module 105 is further arranged to output the retrieved media assets of stage 1020 to narration station 107. A user associated with narration station 107, preferably the human narrator, is arranged to delete any of the received media assets responsive to a user input. Narration station 107 thus allows a user to delete irrelevant or inaccurate media assets. Additionally, in one embodiment, narration station 107 is arranged to rank the received media assets in order of relevancy, responsive to a user input. Narration station 107 is arranged to output the adjusted set of media assets to filtering module 50 via interim output module 105. In the embodiment where a video template and template components were selected in stage 1020, narration station 107 is arranged to change the selection of the video template and/or template components responsive to a user input and the adjustments are output to video creation module 80 via interim output module 105.

In stage 1040, alignment module 70 is arranged to determine time markers in the voice articulated record of stage 1030 for predetermined words in the received textual input of stage 1000. Each time marker represents the point in the voice articulated record in which a particular portion of the text begins. In one embodiment, a time marker is determined for each word in the text. In one embodiment, the time markers are determined responsive to a forced alignment algorithm.

In stage 1050, filtering module 50 is arranged to select a set of media assets from the retrieved plurality of media assets of stage 1020, or the adjusted set of media assets of stage 1030, and the optionally extracted media assets of stage 1000. In one embodiment, the selection is performed responsive to the analysis of stage 1010. In another embodiment, the selection is performed responsive to the length of the input of stage 1000, or the length of the summarized input of stage 1000. In another embodiment, the selection is performed responsive to the length of the narration of stage 1030. In one embodiment, the media assets are selected responsive to the relevancy of the media assets to the text and responsive to the length of the text such that appropriate media assets are selected for the particular length. In the embodiment where in stage 1030 the media assets were ranked according to relevancy, the media assets are further selected responsive to the rankings. In one embodiment, the media assets are further selected responsive to the determined time markers of stage 1040 such that an appropriate media asset is selected for each portion of text associated with the respective time marker. Thus, advantageously, the media assets are selected responsive to the speed of speech of the voice articulated record. In particular, the media assets are thus selected responsive to the actual narration of the voice articulate record of stage 1030, which is preferably a human articulated voice.

In stage 1060, video creation module 80 is arranged to create a video clip responsive to: the received voice articulated record of stage 1030 or the received audio of stage 1000; the determined time markers of stage 1040; and the selected set of media assets of stage 1050. Each media asset is inserted into the video clip at a particular time marker and in one embodiment the media assets are edited responsive to the optionally selected video template and template components of stage 1020. In the event that the selected video template and template components were adjusted in stage 1030, the media assets are edited responsive to the adjusted video template and template components. Advantageously, editing the media assets responsive to the video template and template components provides a video clip which is more accurately correlated with the textual input.

In stage 1070, the created video clip of stage 1060 is output by output module 110. In one embodiment, the created video clip is output to be displayed on a user display. The user display may be associated with a computer, cellular telephone or other computing device arranged to receive the output of output module 110 over a network, such as the Internet, without limitation.

In one embodiment, memory 115 has stored thereon user parameters associated with a plurality of users. Output module 110 is arranged to output the created video clip to a display responsive to the stored user parameters. In particular, output module 110 is in communication with a plurality of user systems, each user system associated with a particular user and comprising a display. Output module 110 is arranged to output the video clip to one or more of the plurality of user systems responsive to the stored user parameters. In one further embodiment, the stored user parameters comprise one or more video clip topics requested by each user system and output module 110 is arranged to output the created video clip to any of the user systems associated with the topic of the created video clip. For example, the created video clip is about the weather and output module 110 is arranged to output the created weather video clip to all of the user systems which have requested video clips about the weather. Thus, a user is presented with a personalized video clip channel.

In one embodiment, a video clip is created for each of a plurality of textual records and for each textual record a video clip is further created for a summarized version of the particular textual record. In one embodiment, the video clips of the summarized versions of the textual records are output by output module 110 to a user display and responsive to a user input, such as a gesture on a portion of a touch screen associated with a particular display of a video clip, the associated video clip of the textual record is displayed. In another embodiment, responsive to the user input the textual record is displayed. In another embodiment, a link to the associated textual record is stored on a memory to be later viewed. In one embodiment, a single video clip is created for a plurality of the summarized textual records and a textual record, or a video clip representation thereof, is displayed responsive to a user input at a particular point in the single video clip. In one non-limiting embodiment, the textual record is a news article and the summarized version is a headline associated with the news article. In one particular embodiment, a plurality of news articles are received from a news publisher and a video clip is created for a series of headlines. As described above, in one embodiment responsive to a user input during a particular temporal point in the news headline video clip where a particular news headline is displayed, the full news article, or a video clip thereof, is displayed. In another particular embodiment, a plurality of news articles are received from a plurality of news publishers and a video clip is created for a plurality of news headlines, as described above. In one embodiment, textual input module 20 is further arranged to select particular news articles from the plurality of received news articles, in one embodiment responsive to user information stored on memory 115 as described above. In one embodiment, the particular articles are selected responsive to areas of interest of a user and/or preferred news providers, thereby a user is displayed a video clip of preferred news headlines. In another non-limiting embodiment, the textual record is a description of tourist properties of a particular geographical location.

In one embodiment, a video clip is created for a plurality of summarized textual records, each associated with the respective complete textual record. In one embodiment, the summarized textual records are search results of a search engine. The video clips of the summarized textual records are output by output module 110 to a user display and responsive to a user input, such as a gesture on a portion of a touch screen associated with a particular display of a video clip, the associated complete textual record, or other information associated therewith, is displayed on the user display.

In one embodiment, information regarding the displayed video clips are stored on memory 115 and output module 110 is arranged to output video clips responsive to the information stored on memory 115 such that a video clip is not displayed twice to the same user. In another embodiment, memory 115 has stored thereon user parameters associated with a plurality of users and output module 110 is arranged to output video clips responsive to the parameters associated with the user viewing the video clips. In one further embodiment, the source of the textual inputs is selected responsive to the information stored on memory 115.

In one embodiment, output module 110 is arranged to replace the output video clip with another video clip responsive to a user input on a user display displaying a video clip. In another embodiment, output module 110 is arranged to adjust the speed of display of the output video clip responsive to a user input on a user display displaying the video clip. In another embodiment, output module 110 is arranged to adjust the point in the output video clip currently being displayed, responsive to a user input on a user display displaying the video clip.

In one embodiment, as described above, a plurality of textual inputs are received by textual input module 20 and textual input module 20 is arranged to: identify a set of textual inputs which are related to the same topic; and create a single textual record from the related set of textual inputs. As described above in relation to stages 1010-1060, a video clip is then created for the single textual record. In one embodiment, one or more portions of each selected textual input is selected, the single textual record being created from the plurality of selected portions. In one embodiment, the plurality of textual inputs are news articles and a set of news articles are selected, each of the selected news articles relating to the same news item. In one further embodiment, portions of each news article are selected and a single news article is created from the selected portions. In one yet further embodiment, each of the selected portions of the news articles relate to a different aspect of the particular news item.

In optional stage 1080, output module 110 is arranged to output a plurality of video clips responsive to a plurality of received textual inputs of stage 1000, each of the plurality of video clips related to a different topic. In particular, stages 1000-1060 as described above are repeated for a plurality of textual inputs, or a plurality of sets of textual inputs, to create a plurality of video clips. As described above, each video clip is created responsive to at least one textual input. In one embodiment, at least one of the plurality of textual inputs is used for more than one video clip. Optionally, each video clip is created responsive to a plurality of textual inputs received from a plurality of sources. Contextual analysis module 30 is arranged to determine which topics relate to each textual input and a textual input relating to a plurality of topics is used for creating a plurality of video clips. In one embodiment, the textual input and associated topic tags are stored on memory 115 to be later used for creating another video clip.

In one further embodiment, a plurality of video clips are output to each of a plurality of user systems responsive to user parameters stored on memory 115, as described above in relation to stage 1070. Thus, each user is provided with their own video clip channel constantly providing updated video clips relating to the topics desired by the user.

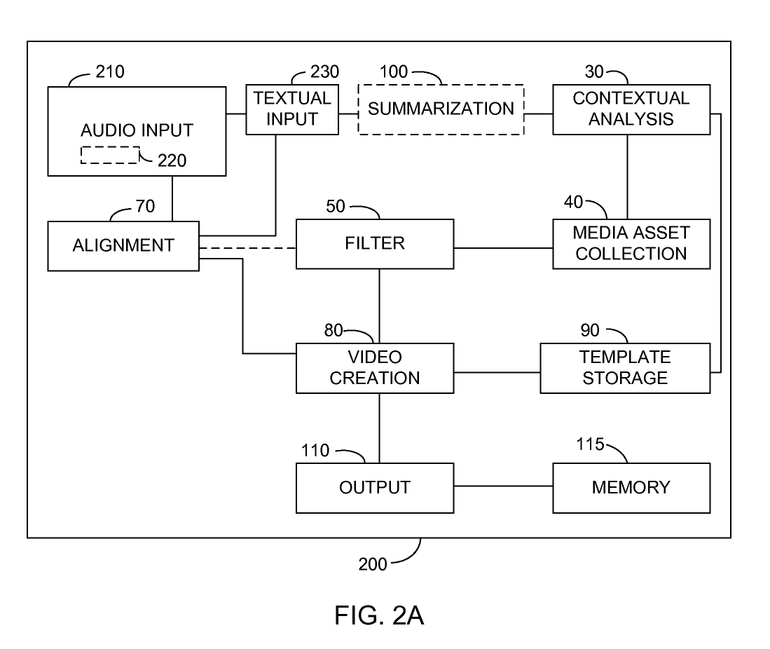

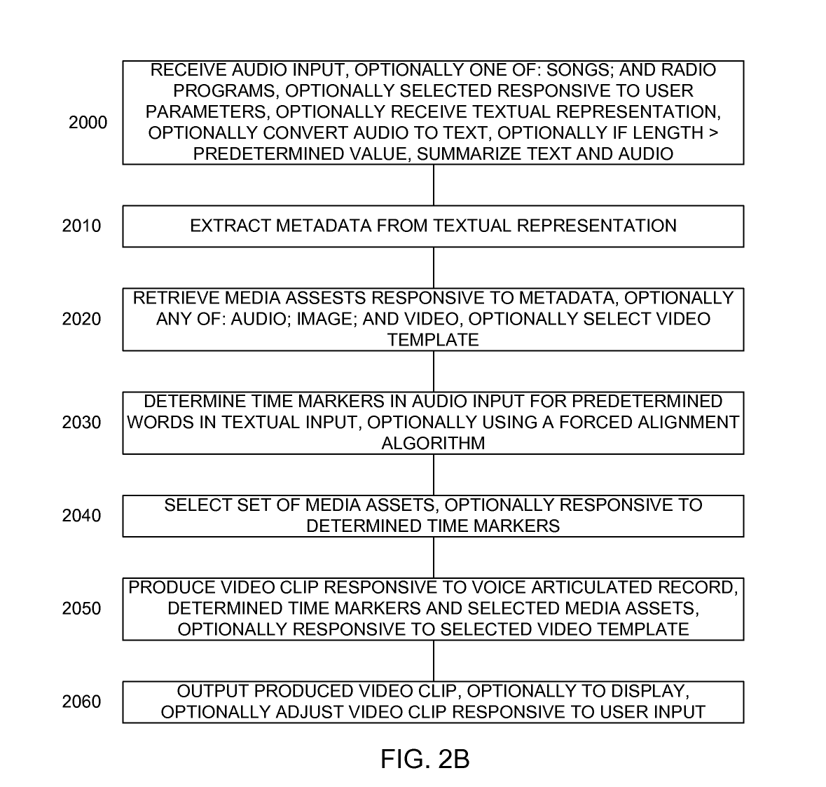

FIG. 2A illustrates a high level block diagram of a system 200 for creating a video clip from an audio input. System 200 comprises: an audio input module 210, in one embodiment comprising an optional speech to text converter 220; a textual input module 230; a contextual analysis module 30; a media asset collection module 40; a filtering module 50; an alignment module 70; a video creation module 80; a template storage 90; an optional summarization module 100; and a memory 115. Audio input module 210 is in communication with one or more audio providers and/or databases and with textual input module 230. Contextual analysis module 30 is in communication with textual input module 230, optionally via optional summarization module 100, and media asset collection module 40. Media asset collection module 40 is further in communication with one or more media asset databases. In one embodiment, the communication is over the Internet. Filtering module 50 is in communication with media asset collection module, with video creation module 80 and optionally with alignment module 70. Alignment module 70 is further in communication with audio input module 210, textual input module 230 and video creation module 80. Video creation module 80 is further in communication with template storage 90 and output module 110, and output module 110 is in communication with memory 115. Template storage 90 is further in communication with contextual analysis module 30.

Each of audio input module 210; speech to text converter 220; textual input module 230; contextual analysis module 30; media asset collection module 40; filtering module 50; alignment module 70; video creation module 80; template storage 90; and optional summarization module 100 may be constituted of special purpose hardware, or may be a general computing device programmed to provide the functionality described herein. The instructions for the general computing device may be stored on a portion of memory 115 without limitation.

The operation of system 200 will now be described by the high level flow chart of FIG. 2B. In stage 2000, an audio input is received by audio input module 210 from a particular audio provider or database. In one embodiment, the audio input is a radio signal, or digital signal. In one non-limiting embodiment, the audio input is a radio program. In another non-limiting embodiment, the audio input is a song or other musical input. As will be described below, in one embodiment the audio input is one of: a song or other musical input; and a radio program. As will be described below, in one embodiment, the audio input is selected from a plurality of textual inputs responsive to user parameters stored on memory 115.

In one embodiment, audio input module 210 is further arranged to receive a textual input comprising a textual representation of the received audio. In another embodiment, optional speech to text converter 220 is arranged to convert the received audio into a textual representation of the received audio. The received textual representation, or the converted textual representation, is output to textual input module 230. In one embodiment, in the event the length of the received input exceeds a predetermined value, optional summarization module 100 is arranged to summarize the textual representation of the received audio input, as described above in relation to stage 1000 of FIG. 1B.

In stage 2010, the textual representation of the audio input of stage 2000 is analyzed by contextual analysis module 30 and metadata is extracted, as described above in relation to stage 1010. In the embodiment where the input of stage 2000 is summarized, the summarized input is analyzed by contextual analysis module 30.

In stage 2020, as described above in relation to stage 1020, media asset collection module 40 is arranged to retrieve a plurality of media assets from one or more media asset databases, responsive to the extracted metadata of stage 2010. In one embodiment, as described above, media asset collection module 40 is further arranged to compare the extracted metadata of stage 1010 to properties of the video templates and template components stored on template storage 90 and select a particular video template and particular template components responsive to the comparison. In one embodiment, as described above in relation to stage 1030, the retrieved media assets are output to a narration station, such as narration station 107 of system 10, and are adjusted responsive to a user input.

In stage 2030, alignment module 70 is arranged to determine time markers in the audio input of stage 2000 for predetermined words in the textual representation of the audio input, as described above in relation to stage 1040.

In stage 2040, as described above in relation to stage 1050, filtering module 50 is arranged to select a set of media assets from the retrieved plurality of media assets of stage 2020, or the adjusted set of media assets, responsive to the analysis of stage 2010. As indicated above, an adjusted set of media assets may be supplied responsive to a narration station 107 as described above in relation to system 10. As described above, in one embodiment the selection is further performed responsive to the determined time markers of stage 2030.

In stage 2050, as described above in relation to stage 1060, video creation module 80 is arranged to create a video clip responsive to: the received audio of stage 2000; the determined time markers of stage 2030; and the selected set of media assets of stage 2040. Each media asset is inserted into the video clip at a particular time marker and in one embodiment the media assets are edited responsive to the optionally selected video template and template components of stage 2020. In stage 2060, the created video clip is output by output module 110. In one embodiment, the created video clip is output to be displayed on a user display. In another embodiment, the created video clip is output to a data provider to be later displayed on a user display.

As described above, in one embodiment information regarding the displayed video clips is stored on memory 115 and output module 110 is arranged to output video clips responsive to information stored on memory 115 such that a video clip is not displayed twice to the same user. In another embodiment, memory 115 has stored thereon information regarding a plurality of users and output module 110 is arranged to output video clips responsive to the information associated with the user viewing the video clips. In one further embodiment, the source of the audio inputs is adjusted responsive to the information stored on memory 115. In one embodiment, output module 110 is arranged to replace the output video clip with another video clip responsive to a user input on a user display displaying the output video clip. In another embodiment, output module 110 is arranged to adjust the speed of display of the output video clip responsive to a user input on a user display displaying the output video clip.

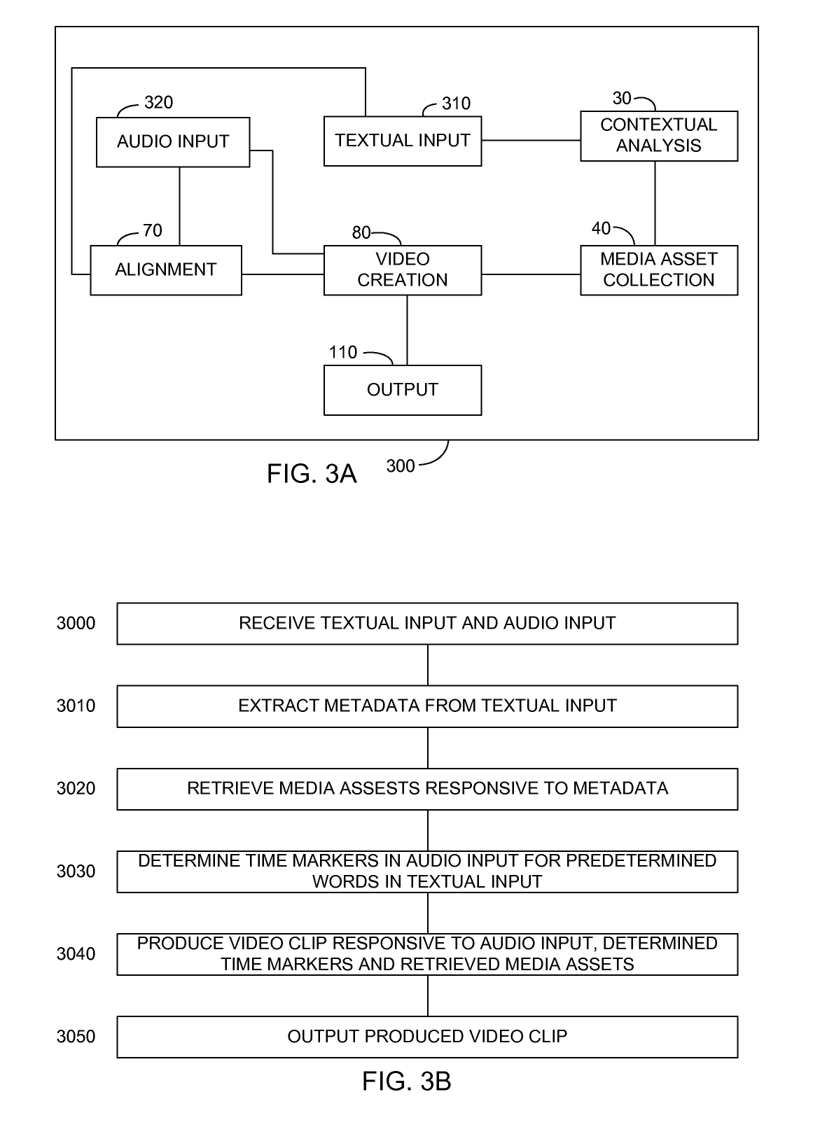

FIG. 3A illustrates a high level block diagram of a system 300 arranged to create a video clip from a received input. System 300 comprises: a textual input module 310; an audio input module 320; a contextual analysis module 30; a media asset collection module 40; an alignment module 70; a video creation module 80; and an output module 110. Textual input module 310 is in communication with contextual analysis module 30 and alignment module 70. Audio input module 320 is in communication with alignment module 70 and video creation module 80. Contextual analysis module 30 is in communication with media asset collection module 40 and media asset collection module 40 is in communication with video creation module 80. Video creation module 80 is in communication with output module 110.

Each of textual input module 310; audio input module 320; contextual analysis module 30; media asset collection module 40; alignment module 70; video creation module 80; and output module 110 may be constituted of special purpose hardware, or may be a general computing device programmed to provide the functionality described herein. The instructions for the general computing device may be stored on a portion of a memory, (not shown) without limitation.

The operation of system 300 will now be described by the high level flow chart of FIG. 31B. In stage 3000, a textual input is received by textual input module 310 and an audio input is received by audio input module 320. The audio input is a recorded audio and the textual input is a textual representation of the recorded audio. In one embodiment, as described above, the textual input is received from a data provider or a database. In another embodiment, the textual input is created from a conversion of the audio input into a textual representation of the audio input. In one embodiment, the audio input is received from a particular audio provider or database. In another embodiment, the audio input is a voice articulated record received from a user station (not shown).

In stage 3010, the textual input of stage 3000 is analyzed by contextual analysis module 30 and metadata is extracted, as described above in relation to stage 1010. In stage 3020, as described above in relation to stage 1020, media asset collection module 40 is arranged to retrieve a plurality of media assets from one or more media asset databases, responsive to the extracted metadata of stage 3010.

In stage 3030, alignment module 70 is arranged to determine time markers in the audio input of stage 3000 for predetermined words in the textual input of stage 3000, as described above in relation to stage 1040.

In stage 3040, as described above in relation to stage 1060, video creation module 80 is arranged to create a video clip responsive to: the received audio input of stage 3000; the determined time markers of stage 3030; and the retrieved media assets of stage 3020. Each media asset is inserted into the video clip at a particular time marker and in one embodiment the media assets are edited responsive to predetermined editing rules, as described above. In stage 3050, the created video clip is output by output module 110. In one embodiment, the created video clip is output to be displayed on a user display. In another embodiment, the created video clip is output to a data provider to be later displayed on a user display.

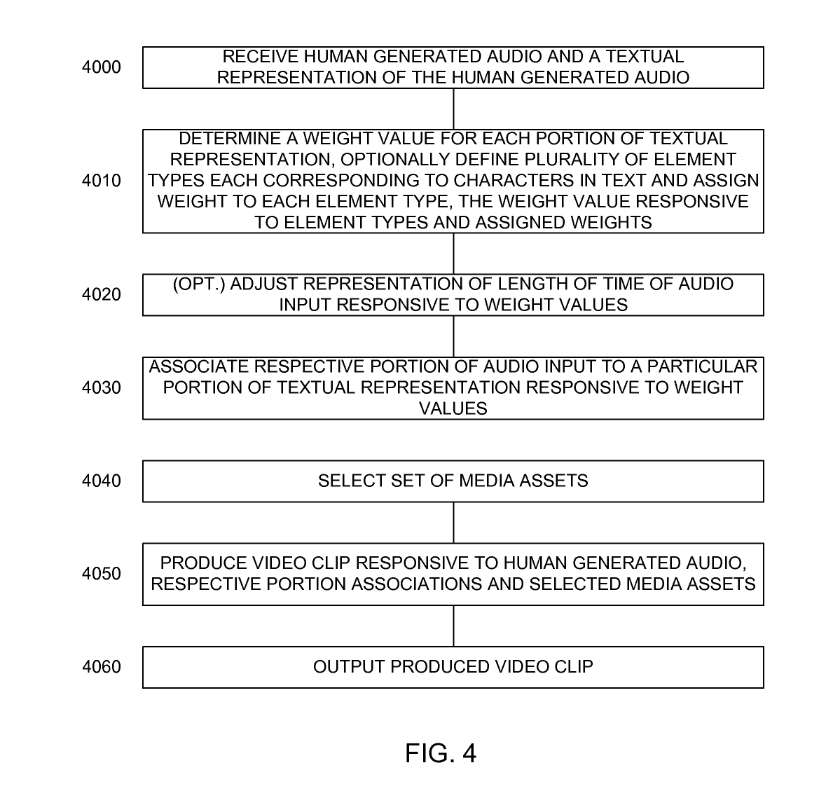

FIG. 4 illustrates a high level flow chart of a method of producing a video clip, according to certain embodiments. In stage 4000, a human generated audio and a textual representation of the human generated audio are received, as described above. Optionally, as described above, the textual representation is transmitted to a narrating station where a narrator narrates the text thereby generating the human generated audio.

In prior art methods of synchronizing text and human generated audio, speech to text engines are utilized. In particular, a portion of the audio signal containing speech is analyzed and matched with a word in the text. The next portion in the audio signal is then analyzed and matched with the next word in the text, and so on. Unfortunately, this method suffers from significant inaccuracies as the word represented by the portion of the audio signal is not always correctly identified. Additionally, when such an error occurs the method cannot correct itself and a cascade of errors follows. The following synchronization method overcomes some of these disadvantages.

In stage 4010, a weight value is determined for each of a plurality of portions of the textual representation of stage 4000. Optionally, a plurality of element types are defined, each element type corresponding to different text characters. A weight is assigned to each element type. The weight of each element type represents the relative time during which such an element type is assumed to be heard when spoken, or silence to be heard while it is encountered while reading, e.g. a period. In one non-limiting embodiment, the element types and their weights are:

1. Word (weight=1);

2. Space (any type of white space, including space, TAB, etc.) (weight=0);

3. Number (weight=1);

4. Comma (weight=1);

5. Semicolon (weight=0.75);

6. Period (weight 3);

7. Paragraph marker (Carriage Return+Line Feed) (weight=2);

8. Characters which have no speech representation, such as ‘!’, ‘?’, ‘(‘and’)’: (weight=0);

9. Characters which have a particular word representation, such as ‘@’, ‘$’, ‘%’ and ‘&’: (weight=1);

The weight value of each portion of the textual representation is responsive to the element types and their weights. In one embodiment, a token weight is determined for each element type in the text, the token weight determined responsive to the element type weight and length. For example, if an element type Word has a weight of 1, a 5 letter word will be assigned a token weight of 5. For characters which have a particular word representation, such as ‘$’, the character is assigned the token weight of the representing word. The weight value of each text portion is thus defined as the sum of the token weights of all of the element types in the text portion. In one non-limiting embodiment, each text portion is defined as comprising only a single element type.

In optional stage 4020, a representation of the length of time of the human generated audio of stage 4000 is adjusted responsive to the determined weight values of stage 4010. In one embodiment, the sum of the weight values of all of the portions of the text is determined. The duration of the recorded text is then divided by the weight value sum to define a unit of time equivalent to one unit duration weight. Each portion of the text is then assigned its appropriate calculated duration responsive to the defined unit duration weight and the length of the portion. For example, if the recorded text duration is 12 seconds (or 12,000 milliseconds), and the sum of weight values of the text is 1,400, then a single unit duration weight is defined as 12,000/1,400=±85.71 milliseconds. If the text portion comprises a 5 letter word, its calculated duration would be 85.71×5=±428 milliseconds.

In stage 4030, a respective portion of the human generated audio is associated to a particular portion of the textual representation of stage 4000 responsive to the determined weight values of stage 4010. In one embodiment, as described in relation to optional stage 4020, the respective portion of the human generated audio is associated to a particular portion of the textual representation responsive to the determined calculated durations of each text portion.

In the event that there is a miscalculation of the weight of a particular text portion, there will be a misalignment between the speech and the particular text portion, however the method of optional stage 4020 will cause the misalignment to correct itself as the speech progresses because the miscalculated weight of each text portion will accumulate to compensate for the misalignment. For example, in the event that a particular text portion is determined to be longer than it really is, the weight value sum of the entire text will be greater than it really is. Therefore, the single unit duration weight will be shorter than it should be and will slowly compensate for the misalignment at the text portion which exhibits the error. For a short text, the accumulating compensation will be greater for each text portion than in a longer text. In any event, the beginning of the first token and the end of the last token will be synchronized with the audio.

Thus, the above described method of synchronizing text with narrated speech provides improved speech to text synchronization without any information about the recorded audio other than its duration and which is independent of language.

In stage 4040, a set of media assets is selected, as described above in relation to stage 1050 of FIG. 1B. In stage 4050, a video clip is produced responsive to the human generated audio of stage 4000, the respective associated audio portions of stage 4030 and the selected media assets of stage 4040, as described above in relation to stage 1060 of FIG. 1B. In stage 4060, the produced video clip of stage 4050 is output to a display.

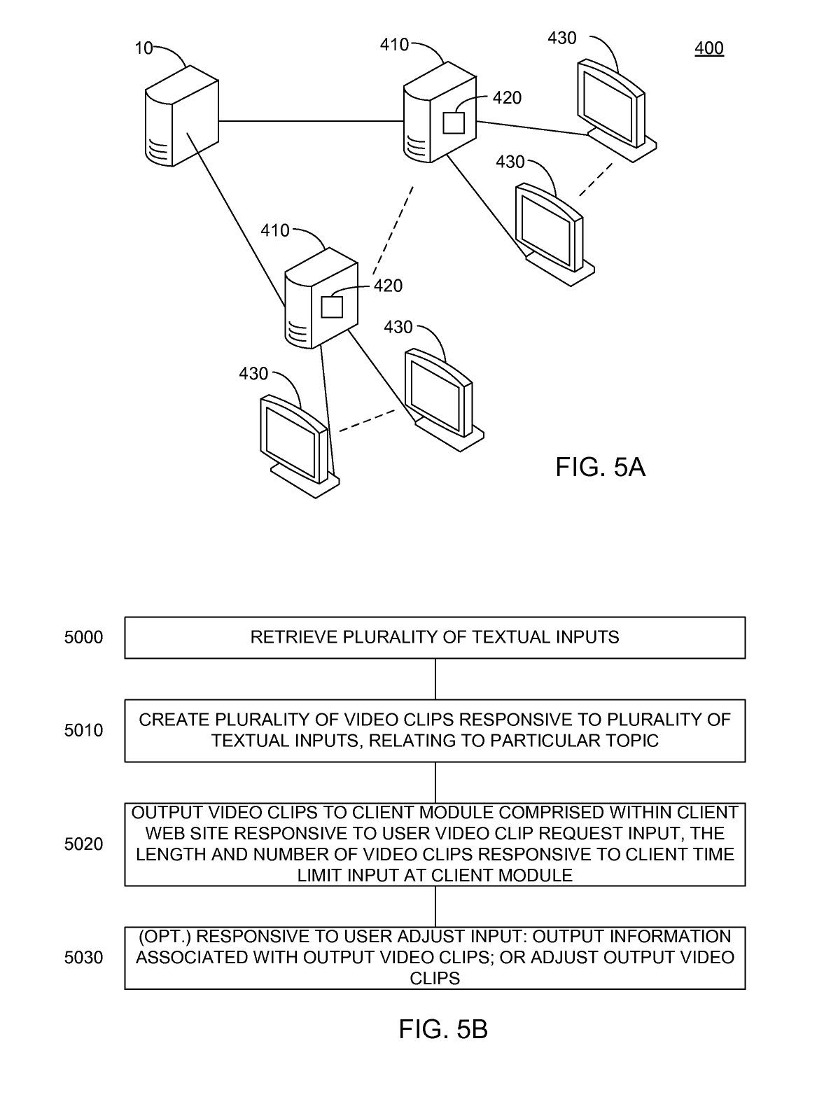

FIG. 5A illustrates a high level schematic diagram of a system 400 for generating multimedia content; and FIG. 5B illustrates a high level flow chart of the operation of system 400, the FIGS. Being described together. System 400 comprises: system 10 of FIG. 1A; a plurality of client servers 410 in communication with system 10, each client server 410 arranged to generate a client web site comprising a client module 420; and a plurality of user displays 430 in communication with client servers 410. Each user display 430 is illustrated as being in communication with a single client server 410, however this is not meant to be limiting in any way and each user display 430 may be in communication with any number of client servers 410, without exceeding the scope.

In one embodiment, client module 420 comprises a software application, optionally a web widget. Client module 420 is associated with a particular topic and comprises a predetermined time limit for the amount of time video clips are to be displayed by client module 420. In one embodiment, the video clip time limit is determined by an administrator of the web site comprising the client module 420 inputting a client time limit input on client module 420. Each user display 430 is in communication with an associated user system, preferably comprising a user input device. System 400 is illustrated as comprising system 10 of FIG. 1A however this is not meant to be limiting in any way. In another embodiment, system can be replaced with systems 200 or 300, as described above in relation to FIGS. 2A and 3A, without exceeding the scope.

In stage 5000, system 10 is arranged to retrieve a plurality of textual inputs, as described above in relation to stage 1000 of FIG. 1B. In stage 5010, a plurality of video clips are created responsive to the plurality of retrieved textual inputs, as described above in relation to stages 1010-1080 of FIG. 1B, the plurality of video clips being related to a particular topic. In stage 5020, the plurality of video clips are output to one or more client modules 420 associated with the topic of the video clips. In particular, the video clips are output to the respective client module 420 responsive to a user video clip request input at client module 420, optionally responsive to a user gesture on an area of the respective user display 430 associated with the client module 420. The number and lengths of the video clips output to each client module 420 are selected responsive to the defined video clip time limit. In one embodiment, where the video clip time limit is defined as “endless”, i.e. video clips are displayed for an unlimited amount of time, sets of video clips are constantly output to client module 420, the number and lengths of the video clips of each set selected responsive to a predetermined time limit. For example, a first set of video clips are output, the number and length of the video clips of the first set selected such that the first set lasts 10 minutes. When the first set is completed, a second 10 minute video clip set, with newly created video clips from updated textual inputs, is output to client module 420.

In optional stage 5030, client module 420 is arranged to detect a user adjust input thereat and communicate the user adjust input to system 10. Responsive to the detected user adjust input, system 10 is arranged to: output to client module 420 information associated with the output video clips; or adjust the output video clips. In particular, in one non-limiting embodiment a user can choose any of: skipping to the next video clip; opening a web window which will display the original source article of one or more textual inputs associated with the displayed video clip; viewing the textual representation of the human generated audio of the video clip, i.e. the textual input; and skipping to another temporal point in the displayed video clip, optionally responsive to a selection of a particular word in the displayed textual representation.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described herein above. Rather the scope of the present invention is defined by the appended claims and includes both combinations and sub-combinations of the various features described hereinabove as well as variations and modifications thereof which would occur to persons skilled in the art upon reading the foregoing description and which are not in the prior art.

1. A system arranged to generate multimedia content, the system comprising:
a textual input module arranged to receive at least one textual input;
an audio input module arranged to receive an audio input, wherein the received audio input is a human generated audio and the at least one textual input is a textual representation of the human generated audio;
a contextual analysis module in communication with said at least one textual input module and arranged to extract metadata from the received at least one textual input;
a media asset collection module arranged to retrieve a plurality of media assets responsive to the metadata of the received at least one textual input;
an alignment module in communication with said audio input module and said at least one textual input module, said alignment module arranged to determine time markers in the received audio input for a plurality of portions of the received at least one textual input;
a video creation module arranged to create a video clip responsive to the received audio input, the determined time markers and the retrieved plurality of media assets of said media asset collection module; and
an output module arranged to output said created video clip.

2. The system according to claim 1, further comprising:
a processor;
a memory, having instructions stored thereon,
wherein said processor is arranged to execute the instructions stored on said memory thereby performing the operations of one of said textual input module, audio input module, contextual analysis module, media asset collection module, alignment module, video creation module and output module.

3. The system according to claim 1, further comprising:
a filtering module associated with said asset collection module and arranged to select a set of media assets from the retrieved plurality of media assets responsive to said determined time markers.

4. The system according to claim 1, wherein the received audio input comprises a voice articulated record of the received at least one textual input.

5. The system according to claim 1, wherein the metadata comprises: entities, values for the entities, and social tags.

6. The system according to claim 1, wherein each of the media assets are selected from the group consisting of: an audio media asset, an image media asset and a video media asset.

7. The system according to claim 1, further comprising a template storage in communication with the video creation module, said template storage arranged to store a plurality of video templates,
wherein the video creation module is further arranged to:
select a particular video template from said template storage responsive to the extracted metadata from the at least one textual input, wherein said video clip is produced in accordance with the selected particular video template.

8. The system according to claim 7, wherein each of the stored plurality of video templates is associated with a background audio track, wherein the video creation module is further arranged to utilize the associated background audio track in said produced video clip.

9. The system according to claim 1, wherein said alignment module employs a forced alignment algorithm to determine the time markers in the received audio input.

10. The system according to claim 1, further comprising an interim output module arranged to output information regarding said received at least one textual input in association with at least a portion of the selected set of media assets to a narrator station,
wherein the received audio input is a voice articulated record of the at least one textual input, said narrator station arranged to provide said voice articulated record, and
wherein said narrator station is further arranged to delete at least one of the retrieved media assets.

11. The system according to claim 10, wherein said output information regarding said received at least one textual input comprises said received at least one textual input.

12. The system according to claim 1, further comprising a summarization module in communication with said at least one textual input module, said summarization module arranged, in the event that the length of said received at least one textual input exceeds a predetermined value, to extract a redacted text,
wherein the audio input comprises a voice articulated record, and
wherein said voice articulated record reflects said redacted text.

13. The system according to claim 1, further comprising:
a memory, said memory having stored thereon user parameters associated with a plurality of users,
wherein one of the received at least one textual input and the received audio input is selected from a plurality of inputs, the selection performed responsive to a user parameter.

14. The system according to claim 1, wherein said output module is arranged to output said created video clip to a display, and
wherein said output module is arranged to adjust said displayed video clip responsive to a user input on the display.

15. The system according to claim 1, wherein said output module is arranged to output said created video clip to a display,
wherein said output module is arranged to output information associated with said displayed video clip to the display, responsive to a user input on the display.

16. The system according to claim 1, wherein the at least one textual input is selected from the group consisting of: news articles; news headlines; search results of an Internet search engine; and textual descriptions of a geographical location.

17. The system according to claim 16, wherein the at least one textual input comprises a plurality of textual inputs,
wherein said output module is arranged to output said created video clip to a display, and
and wherein said output module is arranged, responsive to a user input on the display, to output to the display information associated with a particular one of the plurality of textual inputs.

18. The system according to claim 1, wherein the at least one textual input comprises a plurality of textual inputs,
wherein said textual input module is further arranged to:
identify a set of the received textual inputs which are related to the same topic; and
create a single textual record from said identified set of textual inputs,
wherein said created single textual record is a textual representation of the received human generated audio,
wherein said metadata extraction is from said created single textual record, and
wherein said determined time markers are determined for predetermined words in said created single textual record.

19. The system according to claim 18, wherein the plurality of textual inputs are retrieved from a plurality of sources,
wherein the system is arranged to output a plurality of video clips, each video clip relating to a different topic, said output plurality of video clips created responsive to a plurality of textual inputs, and
wherein one of the plurality of textual inputs is used for both a first and a second of the output plurality of video clips.

20. The system according to claim 1, wherein the audio input is selected from the group consisting of: radio programs; and songs.

21. The system according to claim 1, wherein said arrangement of said alignment module to determine time markers comprises an arrangement to:
determine a weight value for each of the portions of said at least one textual input; and
associate a respective portion of said audio input to a particular portion of said at least one textual input responsive to each of said determined weight values.

22. The system according to claim 20, wherein said weight value determination comprises an arrangement to:
define a plurality of element types, each element type corresponding to one or more particular characters in said at least one textual input; and
assign a particular weight to each of said defined element types, said weight value determination responsive to said defined element types and assigned weights, and
wherein said association of a respective portion of said audio input to a particular portion of said at least one textual input comprises an arrangement to adjust a representation of the length of time of said audio input responsive to said determined weight values, said association responsive to said adjustment.

23. The system according to claim 1, further comprising a memory having stored thereon user parameters associated with a plurality of users, wherein the system is arranged, for each of the plurality of users, to output a plurality of video clips to a display associated with the user, said output plurality of video clips created responsive to a plurality of textual inputs, the plurality of textual inputs retrieved responsive to the stored associated user parameters.

24. The system according to claim 1, wherein the system is arranged to output a plurality of video clips relating to a predetermined topic, said output plurality of video clips created responsive to a plurality of textual inputs,
wherein said output module is arranged to output said created plurality of video clips to a client module responsive to a user video clip request input at the client module, the client module comprised within a client web site, and
wherein the length and number of video clips output to the client module is responsive to a client time limit input at the client module.

25. The system according to claim 24, wherein said output module is arranged, responsive to a user adjust input, to:
output information associated with said output video clips; or
adjust said output video clips.

26. A method for generating multimedia content, the method comprising:
receiving at least one textual input;
receiving an audio input, the received audio input being a human generated audio and the received at least one textual input being a textual representation of the human generated audio;
extracting metadata from the received at least one textual input;
retrieving a plurality of media assets responsive to said extracted metadata of the received at least one textual input;
determining time markers in the received audio input for predetermined words in the received at least one textual input;
creating a video clip responsive to the received audio input, said determined time markers, and said retrieved plurality of media assets; and
outputting said created video clip.

27. The method according to claim 26, further comprising:
selecting a set of media assets from said retrieved plurality of media assets responsive to said determined time markers.

28. The method according to claim 26, wherein the received audio input comprises a voice articulated record of the received at least one textual input.

29. The method according to claim 26, wherein the metadata comprises: entities, values for the entities, and social tags.

30. The method according to claim 26, wherein each of the media assets are selected from the group consisting: an audio media asset, an image media asset and a video media asset.

31. The method according to claim 26, further comprising:
selecting a particular video template from a template storage responsive to the extracted metadata from the at least one textual input, wherein said video clip is produced in accordance with the selected particular video template.

32. The method according to claim 31, wherein the selected particular video template is associated with a background audio track, the method further comprising selecting and utilizing one of the associated background audio tracks in said produced video clip.

33. The method according to claim 26, wherein said determining time markers is accomplished responsive to a forced alignment algorithm.

34. The method according to claim 26, further comprising:
outputting information regarding said received at least one textual input in association with at least a portion of the selected set of media assets to a user station,
wherein the received audio input is a voice articulated record of the at least one textual input, said user station arranged to provide said voice articulated record, and
wherein said user station is further arranged to delete at least one of the retrieved media assets.

35. The method according to claim 34, wherein said output information regarding said received at least one textual input comprises said received at least one textual input.

36. The method according to claim 26, further comprising:
in the event that the length of said received at least one textual input exceeds a predetermined value, extracting a redacted text,
wherein the received audio input comprises a voice articulated record, and
wherein said voice articulated record reflects said redacted text.

37. The method according to claim 26, further comprising:
selecting one of the received at least one textual input and the received audio input from a plurality of inputs responsive to a user parameter.

38. The method according to claim 26, wherein said outputting is to a display, the method further comprising:
adjusting said displayed video clip responsive to a user input on the display.

39. The method according to claim 19, wherein said outputting is to a display, the method further comprising:
outputting information associated with said displayed video clip to the display, responsive to a user input on the display.

40. The method according to claim 19, wherein the textual input is selected from the group consisting of: news articles; news headlines; search results of an Internet search engine; and textual descriptions of a geographical location.

41. The method according to claim 40, wherein said received at least one textual input comprises a plurality of textual inputs, the method further comprising:
outputting information associated with a particular one of said received plurality of textual inputs, responsive to a user input on the display.

42. The method according to claim 26, wherein said received at least one textual input comprises a plurality of textual inputs, the method further comprising:
identifying a set of said received textual inputs which are related to the same topic; and
creating a single textual record from said identified set of textual inputs,
wherein said created single textual record is a textual representation of the received human generated audio
wherein said extracting metadata comprises extracting metadata from said created single textual record, and
wherein said time markers are determined for predetermined words in said created single textual record.

43. The method according to claim 42, wherein the plurality of textual inputs are retrieved from a plurality of sources,
wherein the method further comprises outputting a plurality of video clips, each video clip relating to a different topic, said output plurality of video clips created responsive to a plurality of textual inputs, and
wherein one of the plurality of textual inputs is used for both a first and a second of the output plurality of video clips.

44. The method according to claim 26, wherein the audio input is selected from the group consisting of: radio programs; and songs.

45. The method according to claim 26, wherein said time marker determining comprises:
determining a weight value for each of the portions of said at least one textual input; and
associating a respective portion of said audio input to a particular portion of said at least one textual input responsive to each of said determined weight values.

46. The method according to claim 45, wherein said weight value determining comprises:
defining a plurality of element types, each element type corresponding to one or more particular characters in said at least one textual input; and
assigning a particular weight to each of said defined element types, said weight value determination responsive to said defined element types and assigned weights, and
wherein said associating a respective portion of said audio input to a particular portion of said at least one textual input comprises adjusting a representation of the length of time of said audio input responsive to said determined weight values, said association responsive to said adjustment.

47. The method according to claim 26, further comprising, for each of the plurality of users, outputting a plurality of video clips to a display associated with the user, said output plurality of video clips created responsive to a plurality of textual inputs, the plurality of textual inputs retrieved responsive to user parameters stored on a memory.

48. The method according to claim 26, wherein the method further comprises outputting a plurality of video clips relating to a predetermined topic, said output plurality of video clips created responsive to a plurality of textual inputs,
wherein said outputting said created plurality of video clips is to a client module, said outputting said created plurality of video clips responsive to a user video clip request input at the client module, the client module comprised within a client web site, and
wherein the length and number of video clips output to the client module is responsive to a client time limit input at the client module.

49. The method according to claim 48, further comprising, responsive to a user adjust input:
outputting information associated with said output video clips; or
adjusting said output video clips.
